(19) United States
(12) Patent Application Publication
(10) Pub. No.: US 2016/0005126 A1
(43) Pub. Date: Jan. 7, 2016

(54) SYSTEM AND METHOD FOR INVESTMENT PORTFOLIO RECOMMENDATIONS BASED ON PURCHASING AND RETAIL LOCATION

(71) Applicant: MASTERCARD INTERNATIONAL INCORPORATED, Purchase, NY (US)

(72) Inventor: DEBASHIS GHOSH, Charlotte, NC (US)

(73) Assignee: MASTERCARD INTERNATIONAL INCORPORATED, Purchase, NY (US)

(21) Appl. No.: 14/323,928

(22) Filed: Jul. 3, 2014

(51) Int. Cl. G06Q 40/06

(52) U.S. Cl. CPC G06Q 40/06

(57) ABSTRACT

Systems and methods are provided for scanning a code associated with, taking a picture of, or otherwise receiving a product or service identifier. Upon recognizing the product or service identifier, the product or service identifier can be linked, mapped, correlated to, or otherwise associated with a company or corporate entity. Upon determining, for example, that the company or corporate entity is publicly owned or traded, one or more investment activities can be undertaken, e.g., purchasing stock in the company or corporate entity, viewing financial information associated with the company or corporate entity, etc.

### TECHNICAL FIELD

The present disclosure is generally related to electronic transaction processing. More particularly, the present disclosure is directed to systems and methods for leveraging retail location and purchasing information to provide investing recommendations.

### BACKGROUND

The use of payment cards for a broad spectrum of cashless transactions has become ubiquitous in the current economy, accounting for hundreds of billions of dollars in transactions during a single year. For example, MasterCard International Incorporated, one example of a payment card network, processes upwards of 160 million transactions per hour across 230 countries. However, information about individual products or services that are actually purchased is not obtained or at least, is not revealed or analyzed due to, e.g., privacy concerns. Hence, stock keeping unit or “SKU”-level information generally cannot be leveraged for other purposes.

### SUMMARY

In accordance with one embodiment, a method comprises receiving a product identifier, correlating the product identifier with a product, and correlating the product with a company. The method further comprises identifying a ticker symbol associated with the company, and presenting at least one investment option based on the ticker symbol.

In accordance with another embodiment, a non-transitory computer-readable medium has computer executable program code embodied thereon. The computer executable program code is configured to cause a computer system to correlate a product to a scanned identification code displayed on the product. The computer executable program code is further configured to cause the computer system to correlate the product with a company determined to be associated with the product, and determine whether the company is a publicly traded company. If the company is determined to be publicly traded, the computer executable program code causes the computer system to identify a ticker symbol associated with the company. Thereafter, a plurality of investment-related activity options using the ticker symbol is presented on a graphical user interface menu.

In a further embodiment, a server comprises at least one processor, and at least one memory module storing computer program code. The at least one memory module and stored computer program code are configured to, with the at least one processor, cause the server to: determine a product associated with a product code received from an investment application by accessing a first database mapping the product code to the product and retrieving first information identifying the product; determine a company associated with the product by accessing a second database mapping the product to the company and retrieving second information naming the company; determine a ticker symbol associated with the company by accessing a third database mapping the company to the ticker symbol and retrieving the ticker symbol; visually present the ticker symbol; and enable selection of at least one investment option regarding the company utilizing the ticker symbol.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1 illustrates an example payment card transaction processing system.

FIG. 2 illustrates an example of providing investment portfolio recommendations in accordance with various embodiments.

FIG. 3 illustrates an example communications system in which various embodiments may be implemented.

FIG. 4 illustrates an example information system with which the presentation of investment recommendations in accordance with various embodiments may be implemented.

FIG. 5 is a flow chart illustration various operations that may be performed to present investment recommendations in accordance with various embodiments.

FIG. 6 illustrates an example computing module that may be used in implementing features of various embodiments.

The drawings are described in greater detail in the description and examples below.

### DETAILED DESCRIPTION

The details of some example embodiments of the methods and systems of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

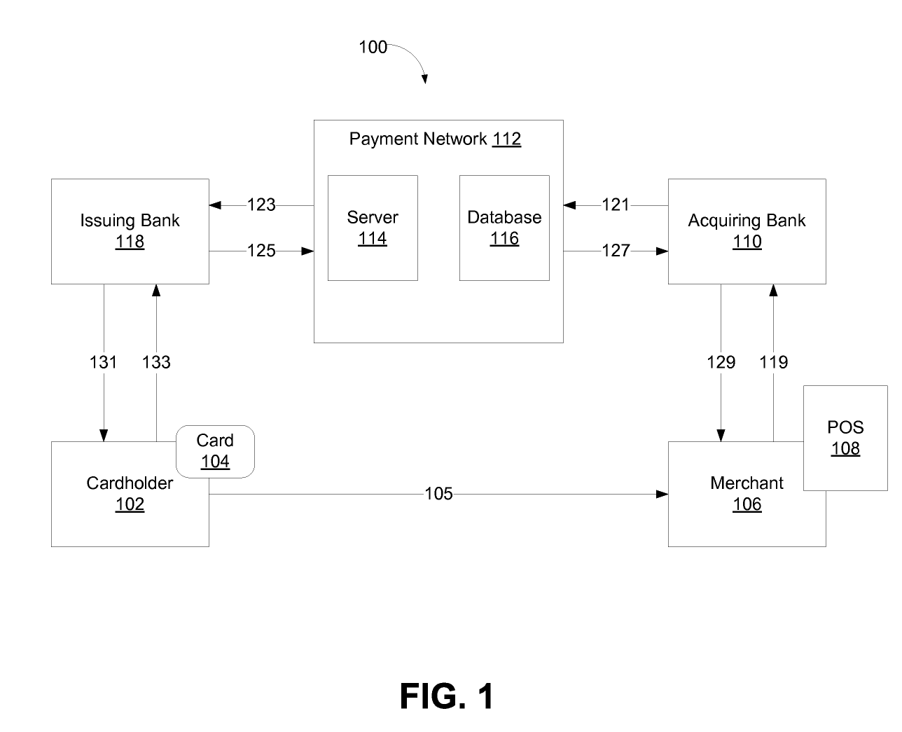

Transaction processing of electronic payments can include both an authorization side and a clearance side. The authorization side may involve the process of confirming that a cardholder has a sufficient line of credit to cover a proposed payment. The clearance side of the transaction may involve the process of moving funds from an issuing bank to an acquiring merchant bank. FIG. 1 depicts an example payment card transaction processing system 100 showing both the authorization side and the clearance side of card-based payments.

In a typical card-based payment system transaction, a cardholder 102 presents a credit/debit/prepaid card 104 to a merchant 106 for the purchase of goods and/or services. This transaction is indicated by arrow 105. A “card” 104, as used herein, can refer to a conventional magnetic-stripe credit, debit card, or similar proximity payment device (utilized on its own or incorporated into another device such as a mobile telephone, personal digital assistant (PDA), etc.) having near field communications (NFC) capabilities, such as a radio frequency identification (RFID) chip implemented therein. A “card” 104 can further refer to virtual or limited use account numbers and electronic wallets.

It is understood that prior to the occurrence of such a transaction, cardholder 102 was issued card 104 by an issuing bank 118. Moreover, it will be understood that merchant 106 has established a relationship with an acquiring bank 110, thereby allowing merchant 106 to receive credit/debit cards as payment for goods and/or services. That is, merchant banks and issuing banks may participate in various payment networks, including payment network 112. One such payment network is operated by MasterCard International Incorporated, the assignee of the present disclosure.

After presentation of card 104 to merchant 106 by cardholder 102, merchant 106 may send an authorization request (indicated by arrow 119) to acquiring bank 110 via a point-of sale (POS) terminal 108 located at or otherwise controlled by merchant 106. In turn, acquiring bank 110 communicates with payment network 112 (indicated by arrow 121), and payment network 112 communicates with issuing bank 118 (indicated by arrow 123) to determine whether cardholder 102 is authorized to make transaction 105. The issuing bank 118 either approves or disapproves the authorization request and thereafter transmits the response back to merchant 106 (indicated by arrows 125, 127 and 129). Merchant 106 may then either complete or cancel transaction 105 based upon the response to the authorization request.

If transaction 105 is approved, the transaction amount will be sent from issuing bank 118 through payment network 112 to acquiring bank 110. The transaction amount, minus certain fees, will thereafter be deposited within a bank account belonging to merchant 106, a process called clearance. Issuing bank 118 thereafter bills cardholder 102 (indicated by arrow 131) for all transactions conducted over a given period of time by sending a cardholder statement to cardholder 102. Cardholder 102 follows by submission of payment(s) (as indicated by arrow 133) to issuing bank 118. This submission of payment(s) (as indicated by arrow 133) by cardholder 102 may be automated (e.g., in the case of debit transactions), may be initiated by cardholder 102 for the exact amount matching amounts of purchases during the statement period (e.g., charge cards or credit balances paid in full), and/or may be submitted (in part or in whole) over a period of time that thereby reflects the amount of the purchases, plus any financing charges agreed upon beforehand between cardholder 102 and issuing bank 118 (e.g., revolving credit balances).

Payment network 112 preferably includes at least one server 114 and at least one database 116. Server 114 may include various computing devices such as a mainframe, personal computer (PC), laptop, workstation or the like. Server 114 can include a processing device and be configured to implement an authorization and clearance process, which can be stored in computer storage associated with server 114. Database 116 may include computer readable medium storage technologies such as a floppy drive, hard drive, tape drive, flash drive, optical drive, read-only memory (ROM), random access memory (RAM), and/or the like. Server 114 and database 116 may be controlled by software/hardware and may store data to allow it to operate in accordance with aspects of the present disclosure.

POS terminal 108 is in data communication, directly or indirectly, and at least from time to time, with, e.g., an acquirer host computer (not shown) that is part of payment network 112 and is operated for or on behalf of acquiring bank 110, which handles payment card transactions for merchant 106. Server 114 may be operated by or on behalf of the payment network 112, and may provide central switching and message routing functions among the member financial institutions of the payment card network. Issuing bank 118 also preferably makes use of an issuer host computer (not shown), and an access point (not shown) via which the issuer host computer exchanges data messages with server 114. It should be noted that in practice, payment card transaction processing system 100 may involve a large number of cardholders, POS terminals, acquirer host computers, issuer host computers, and access points. In general, the acquirer host computer can receive authorization requests from POS terminals, forward the authorization requests through payment network 112, receive authorization responses, and relay the authorization responses to POS terminal 108. Moreover, the issuer host computer may in general, receive authorization requests from server 114 and transmit authorization responses back to server 114 with respect to the authorization requests.

As previously indicated, although certain information can be gleaned from payment card transaction processing system 100, conventional systems and methods of electronic transaction processing do not leverage SKU-level information regarding the purchase of and payment for products and/or services for other purposes. Accordingly, various embodiments provide systems and methods for associating or correlating, e.g., a product, via some product identifier with a company or corporate entity, and providing a mechanism by which a consumer may engage in one or more investment activities based on the identified company.

In accordance with one embodiment, an investment application may be provided on a device, such as a mobile computing device, smart phone, etc., that can be utilized to scan some form of product or service identifier. Once the product or service identifier has been scanned and recognized, the product or service identifier can be linked, mapped, correlated to, or otherwise associated with a company or corporate entity. Upon determining, for example, that the company or corporate entity is publicly owned or traded, one or more investment activities can be undertaken, e.g., purchasing stock in the company or corporate entity. Hence, the investment application can provide an interface that allows a user of the device to engage in such investment activities, as well as view certain information that may be relevant to or related to the company.

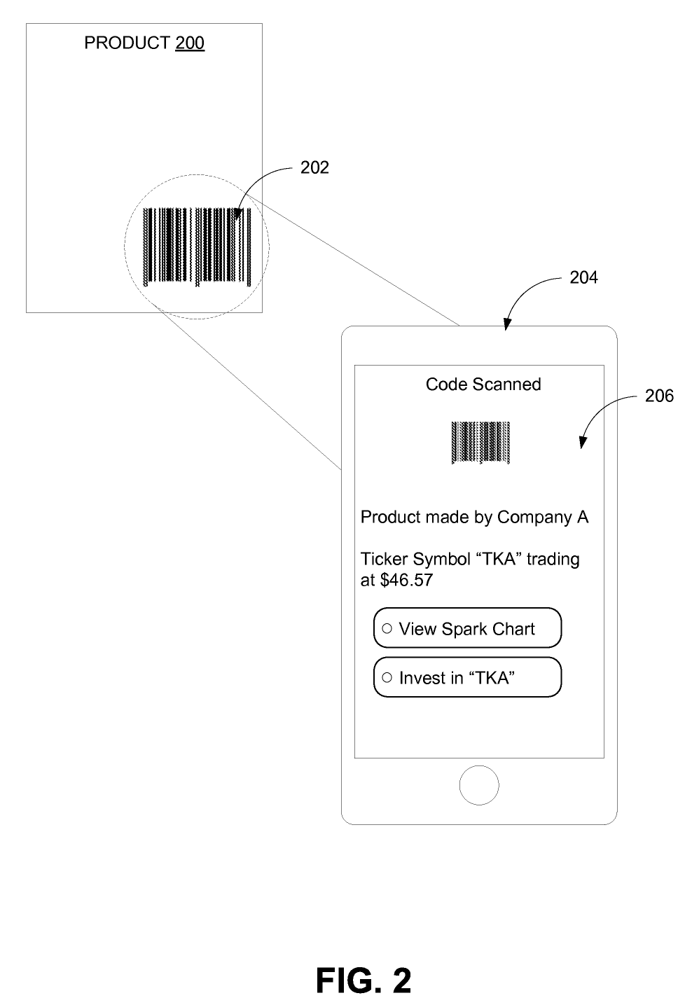

FIG. 2 illustrates an example of providing investment portfolio recommendations in accordance with one embodiment of the present disclosure. FIG. 2 illustrates a product 200, which may be a food product, such as a box of Frosted Flakes® cereal that a consumer sees while shopping at a merchant or business locale, e.g., a grocery store. The consumer, upon noticing that product 200 is in high demand by virtue of product 200 inventory consistently being low at the grocery store, for example, the consumer may utilize an investment application 206 running on device 204, in this example, a smart phone, to scan a universal product code (UPC) 202 shown on product 200 or the packaging for product 200. Investment application 206 may be a standalone application implemented on device 204, a web-based application accessible by device 204, or other appropriate application for performing various functions as described herein.

Investment application 206 may present a graphical user interface (GUI) via a display of device 204 to the consumer. Through the GUI, investment application 206 can present the consumer with certain information regarding product 200, such as the company that produces or markets product 200. Additionally, investment application 206 can present the consumer with a ticker symbol associated with that company, provided, e.g., that the company is publicly traded, along with relevant information, such as a current trading price for stock in that company. For example, upon recognizing UPC 202, application 206 can access one or more databases to correlate UPC 202 to product 200, i.e., Frosted Flakes® cereal, and subsequently to the company that produces product 200, the Kellogg Company. Upon correlating UPC 202 and product 200 to the appropriate company, investment application 206 may then present the consumer with the ticker symbol corresponding to the Kellogg Company, “K.” In the event UPC 202 and product 200 is associated with a privately held entity, investment application 206 can inform the consumer accordingly.

Once the consumer is presented with the ticker symbol, through one or more options presented by investment application 206, the consumer may then engage in one or more investment or investment-related activities.

One such investment-related activity may be to view a sparkline or spark chart for the company. As will be described in greater detail below, a proprietary database maintained by an entity, for example, a payment card network, may be utilized to glean data regarding the performance of that company. Although actual sales data, for example, cannot be provided due to security and/or other regulatory restrictions, company information can be indexed or benchmarked, e.g., across one or more industry components, and presented to the consumer as a spark chart. The consumer can analyze the spark chart, e.g., to determine whether or not his/her instincts regarding the high demand for product 200 translates into a favorable investment opportunity for that consumer.

Further still, and within each payment card transaction processed by an acquiring bank, for example, certain information can be gleaned and stored, such as the amount of each transaction, and the merchant or business at which the transaction occurred. Accordingly, additional indicators or indices, for example, can be derived from such information and subsequently provided to the consumer to provide insight into how a particular merchant or business is performing, its habits, etc., which can be leveraged for use in making investments and/or investment recommendations.

Yet another investment activity that the consumer may engage in would be to purchase stock in that company. For example, upon initially running investment application 206, the consumer may be prompted to link investment application 206 to one or more brokerage firms, such as TD Ameritrade, Fidelity, E*Trade, Charles Schwab, etc. That is, the consumer may provide the requisite information regarding his/her preferred brokerage service along with his/her relevant brokerage service account information to investment application 206. Upon determining that the consumer would like to invest in the company, investment application 206 can redirect to or otherwise provide functionality on behalf of the appropriate brokerage service allowing the consumer to, place a market order to buy a desired amount of stock. It should be noted that investment application 206 can be configured to provide investment activity functionality via an associated electronic trading platform, which can be an alternative to utilizing an aforementioned brokerage firm. Moreover, should the consumer not currently have an account with a brokerage firm, investment application 206 may provide one or more links, e.g., a telephone number, a universal resource locator (URL) address, etc. associated with one or more brokerage firms. It should be further noted that various other types of investment or investment-related activities can be engaged in by the consumer via investment application 206, such as accessing more detailed, publicly available financial information regarding a company, viewing his/her investment portfolio, selling stock in the company, trading options, etc.

Although various embodiments described herein disclose identification of a product or service through a UPC, it should be noted that a product or service identifier may be any unique value suitable for identifying a product or service, such as a SKU, manufacturer part number (MPN), serial number, European article number (EAN), international standard book number (ISBN), or other appropriate value type. In accordance with other embodiments, device 204 may be configured to have augmented reality functionality that can be utilized to identify a product for example. For example, a consumer may utilize device 204 to view or take a picture of a product, such as particular car. Investment application 206, in conjunction with the augmented reality functionality, can identify the maker of that car, and subsequently provide the consumer with the same or similar information and/or investment activity options as described above based on correlating the car with the car manufacturer's ticker symbol. Still other embodiments may obtain ticker symbol information based on the entry of data, such as a company name, by the consumer instead of relying on scanned product or service identifiers.

Another aspect of investment application 206 is that it can leverage information gleaned from, e.g., social media outlets, to provide investment recommendations to a consumer. The consumer may choose to identify one or more social media networks, such as Facebook®, Pinterest™, Tumblr™, etc., to investment application 206 and allow investment application 206 to access certain information and/or statistics that appear on or are associated with the consumer's Facebook® page or account. That is, investment application 206 may utilize one or more algorithms to determine when a particular product is mentioned often enough to present an investment recommendation to the consumer based on trended social media information or number of mentions on a social media network, etc. For example, products of interest can be identified by analyzing products that are “Liked” by the consumer's “Facebook® friends.” Moreover, investment application 206 may be configured such that it can access the consumer's, e.g., online purchase history, through one or more purchasing applications resident on and used by the consumer via device 204. Thus, upon determining a particular product of interest via a social media network, application 206 may obtain, as described herein, a ticker symbol that corresponds to a company related to/associated with the product.

Investment recommendations presented by investment application 206 may also be generated by analyzing previously scanned UPCs or obtained product information. That is, application 206 may discern other companies in a particular product field that may result in advantageous investment opportunities. For example, and referring back to the abovementioned example, where the consumer scans a UPC associated with a particular band of cereal, investment application 206 may further obtain ticker symbols for other companies that produce cereal, and present such information to the consumer for his/her consideration.

In accordance with still other embodiments, NFC technologies and/or location-based services may be utilized to make a consumer aware of and/or recommend investment opportunities for publicly traded companies. For example, in addition to allowing the consumer to identify specific products or services in which he/she may have an interest, proximity marketing can be further leveraged to provide investment recommendations. That is, a consumer may enter or come into close proximity to a business establishment upon which investment application 206 running on device 204 may receive information broadcast by a transmitter located within the business establishment. The transmitter, which can be used to wireless broadcast information, such as advertising content or other types of proximity marketing media or data, can include some identifier or form of indicia which investment application 206 may then ultimately correlate to a ticker symbol. For example, investment application 206 can identify that the consumer has entered or is near a Harris Teeter supermarket, correlate the Harris Teeter supermarket with its parent company or entity, Kroger Company, and present the consumer with the Kroger Company ticker symbol, KR, along with, e.g., investment-related information or recommendations. As described above, the consumer may engage in or more investment activities involving the Kroger Company via investment application 206. It should be noted that product indicia may also be embedded in some form(s) of proximity marketing broadcasts, such as that associated with particular advertising related to a particular product.

Additionally still, investment application 206 may utilize location-based service functionality to determine a location of the consumer utilizing device 204 to proactively send investment recommendations to the consumer. For example, investment application 206/device 204 may determine a location of the consumer and present one or more ticker symbols of, e.g., merchants, proximate to the location of the consumer. The consumer may then engage in one or more investment activities based on the received ticker symbols.

As described above, investment application 206, via device 204, may access or operatively connect to one or more databases, external services (e.g., brokerage firms), etc. Accordingly, device 204 may be configured with communications capabilities to enable such accessing/operative connectivity.

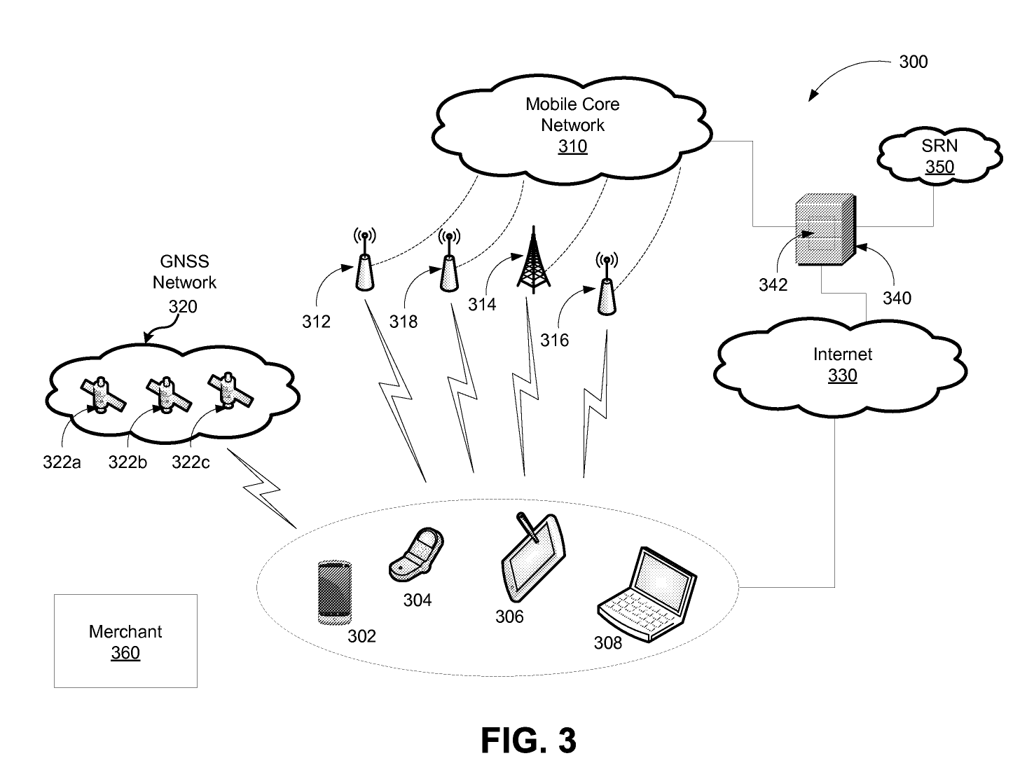

FIG. 3 is a block diagram illustrating an exemplary communication system in which various embodiments may be implemented in accordance with the present disclosure. Referring to FIG. 3, a communications system 300 which includes a plurality of mobile devices, of which mobile devices 302-308 is illustrated. One or more of mobile devices 302-308 can include an investment application or applications for providing investment recommendations/functionality according to various embodiments described in the present disclosure. Exemplary mobile devices may include a smart phone 302 (which may be one example of device 204), a cellular device 304, a personal digital assistant (PDA) 306, and/or a tablet computer 308. Also shown in communication system 300 is a mobile core network 310, a wireless access point (AP) 312, a cellular base station (BS) 314, a Bluetooth® emitter 316, a Near Field Communication (NFC) terminal 318, a global navigation satellite system (GNSS) network 320, a plurality of GNSS satellites 322a-322n, an internet 330, a location server 340, and a satellite reference network (SRN) 350. One or more of mobile core network 310, wireless AP 312, cellular BS 314, Bluetooth® emitter 316, NFC terminal 318, GNSS network 320, GNSS satellites 322a-322n, internet 330, location server 340, and/or satellite reference network (SRN) 350 can be used in assisting to determine the location of one or more of the mobile devices 302-308 for use in the application and/or to provide communications links to the mobile devices 302-308 for allowing mobile devices 302-308 to communicate as described in more detail herein with respect to an investment application as described herein.

Wireless AP 312 may include suitable logic, circuitry, interfaces, and/or code that are operable to provide data services to communication devices, such as one or more of the mobile devices 302-308, in adherence with one or more wireless LAN (WLAN) standards such as, for example, IEEE 802.11, 802.11a, 802.11b, 802.11d, 802.11e, 802.11n, 802.11 ac, 802.11v, and/or 802.11u. Wireless AP 312 may communicate with mobile core network 310 and/or internet 330, via one or more links and/or associated devices for example. In this manner, wireless AP 312 may provide network access to mobile devices 302-308.

Cellular BS 314 may include suitable logic, circuitry, interfaces, and/or code that are operable to provide voice and/or data services to communication devices, such as one or more of the mobile devices 302-308, in adherence with one or more cellular communication standards. Exemplary cellular communication standards may include Global System for Mobile communications (GSM), General Packet Radio Services (GPRS), Universal Mobile Telecommunications System (UMTS), Enhanced Data rates for GSM Evolution (EDGE), Enhanced GPRS (EGPRS), and/or 3GPP Long Term Evolution (LTE). Cellular BS 314 may communicate with mobile core network 310 and/or internet 330, via one or more backhaul links and/or associated devices for example. In this manner, cellular BS 314 may provide network access to mobile devices 302-308, enabling a mobile device running an investment application, such as smart phone 302, to communicate with one or more databases, services, servers, etc. as described herein.

Bluetooth® emitter 316 may include suitable logic, circuitry, interfaces, and/or code that are operable to provide Bluetooth® based connectivity to communication devices, such as one or more of mobile devices 302-308, in adherence with various Bluetooth® and/or Bluetooth® Low Energy (BLE) standards. Bluetooth® emitter 316 may communicate with mobile core network 310 and/or internet 330, via one or more backhaul links and/or associated devices for example. In this manner, Bluetooth® emitter 316 may provide network access to mobile devices 302-308, enabling a mobile device running an investment application, such as smart phone 302 to communicate with, e.g., one or more proximity marketing network elements of a merchant 360.

NFC terminal 318 may include suitable logic, circuitry, interfaces, and/or code that can provide NFC-based connectivity to communication devices, such as one or more of the mobile devices 302-308, in adherence with various short range communication standards such as the Near Field Communications standards. The NFC terminal 318 may communicate with the mobile core network 310 and/or the internet 330, via one or more backhaul links and/or associated devices for example. In this manner, the NFC terminal 318 may provide network access to the mobile devices 302-308. One example implementation of an NFC terminal 318 is for use in a contactless payment system and/or for communicating with, e.g., one or more proximity marketing network elements of merchant 360.

Mobile core network 310 may include suitable logic, circuitry, interfaces, and/or code that are operable to provide interfacing and/or connectivity servicing between access networks, which may be utilized by the mobile devices 302-308, and external data networks such as packet data networks (PDNs) and/or internet 330. Mobile core network 310 may correspond to one or more service providers that provide, control, and/or manage network accessibility available via mobile devices 302-308. In this regard, mobile devices 302-308 may access the mobile core network 310 via wireless AP 312, cellular BS 314, Bluetooth® emitter 316, and/or NFC terminal 318. Mobile core network 310 may communicate various data services, which are provided by external data networks, to associated user devices such as, for example, mobile devices 302-308. In an exemplary aspect of the disclosure, in instances where an investment application is provided to a user device such as smart phone 302, mobile core network 310 may be operable to communicate with location server 340 to obtain location information that can be used by the investment application.

Each of mobile devices 302-308 may include suitable logic, circuitry, interfaces, and/or code for implementing various aspects of the embodiments disclosed herein. In this regard, each of mobile devices 302-308 may be operable to communicate via a plurality of wired and/or wireless connections. Each of mobile devices 302-308 may be operable, for example, to transmit to and/or receive signals from one or more of wireless AP 312, cellular BS 314, Bluetooth® emitter 316, NFC terminal 318, GNSS network 320, and/or internet 330. Also, each of mobile devices 302-308 may be operable to communicate with, and/or receive services provided by internet 330 and/or mobile core network 310. In this regard, mobile devices 302-308 may be operable to utilize investment applications, which can utilize location server 340.

GNSS network 320 may include suitable logic, circuitry, interfaces, and/or code that may provide navigation information to land-based devices via satellite links. In this regard, GNSS network 320 may include, for example, a plurality of GNSS satellites 322a-322n, each of which is operable to provide satellite transmissions based on a GNSS. Exemplary GNSS systems may include, for example, GPS, GLONASS, Galileo-based satellite system, Beidou and/or Compass systems. Accordingly, GNSS network 320 may be operable to provide positioning information via downlink satellite links transmitted from one or more of the plurality of GNSS satellites 322a-322n to enable land-based devices, such as the mobile devices 302-308, to determine their locations. The plurality of GNSS satellites 322a-322n may directly provide positioning information and/or a land-based device may utilize satellite transmissions from different satellites to determine its location using, for example, triangulation based techniques.

SRN 350 may include suitable logic, circuitry, interfaces, and/or code that are operable to collect and/or distribute data for GNSS satellites on a continuous basis. SRN 350 may include a plurality of GNSS reference tracking stations located around the world to provide A-GNSS coverage all the time in both a home network and/or any visited network. In this regard, SRN 350 may utilize satellite signals received from various GNSS constellations, such as, for example, the plurality of GNSS satellites 322a-322n of GNSS network 320.

Location server 340 may include suitable logic, circuitry, interfaces, and/or code that are operable to provide and/or support location based services. In this regard, location server 340 may be operable to store and/or process location related information pertaining to communication devices in system 300, such as one or more of mobile devices 302-308. The location information may be stored in a location reference database 342 in location server 340. Location server 340 may be operable to collect and/or retrieve location information from communication devices. Location server 340 may also be operable to access additional and/or dedicated entities, such as SRN 350 for example, to collect GNSS satellite data, and may be operable to utilize the collected GNSS satellite data to generate GNSS assistance data (A-GNSS data) including, for example, ephemeris data, long term orbit (LTO) data, reference positions and/or time information. Location server 340 may communicate the stored location data when requested to do so.

In operation, location server 340 may be utilized to provide location based services (LBS) in system 300. Location server 340 may maintain, for example, location reference database 342, which may include elements corresponding to each of mobile devices 302-308. Location server 340 may access SRN 350 to collect GNSS satellite data, and may utilize the collected GNSS satellite data to generate GNSS assistance data (A-GNSS data) pertaining to the mobile devices 302-308. Location server 340 may also collect and/or retrieve location information directly from mobile devices 302-308, and/or from other associated entities that interact with mobile devices 302-308 in system 300, such as, for example, wireless AP 312, cellular BS 314, Bluetooth® emitter 316, and/or NFC terminal 318. The retrieved location information may be stored in location reference database 342 in location server 340. Location server 340 may communicate the stored location data, e.g., when requested to do so. Location reference database 342, maintained in location server 340, may be modified, refined, and/or updated using retrieved location information. Location information stored and/or maintained by location server 340 may be utilized to augment and/or substitute for location information received and/or generated based on communication with GNSS network 320, for example, when communication with GNSS network 320 is disturbed.

The location data may also be locally generated, and/or maintained thereafter by devices and/or entities other than location server 340. In this regard, location related data, which typically may be generated and/or maintained by location server 340, may be locally generated, maintained, and/or used by mobile devices 302-308, and/or by service providers thereof. Accordingly, devices and/or entities that typically may be serviced by location server 340, such as mobile devices 302-308, may also perform location related servicing locally. Furthermore, locally generated and/or maintained location related data may be uploaded from mobile devices 302-308, and/or service providers thereof, to location server 340. Uploading the location related data may be performed periodically, on request, and/or based on the configuration of the client devices or entities, and/or location server 340 itself.

The location information stored and/or maintained in location server 340 may be utilized to authenticate, for example, one or more of mobile devices 302-308, users thereof, and/or locations thereof during operations performed by mobile devices 302-308. In this regard, service providers, who may provide access servicing to mobile devices 302-308, may contact location server 340 to request that location server 340 perform authentication procedures, and/or to obtain information necessary for performing the authentication procedures. The service providers may include, for example, cellular, Bluetooth®, WLAN, and/or NFC services providers. For example, a service provider of one of mobile devices 302-308 may request authenticating the mobile device, its user, and location at a given instance. Location server 340 may then perform the necessary authentication procedures, which may be based on existing information in location reference database 342, which is maintained by location server 340. Location server 340 may also perform authentication procedures based on current information, which may be obtained by, for example, communicating with the mobile device, to verify its present location and/or connectivity status or parameters. In this regard, location server 340 may communicate with the mobile device using IP packets that may be communicated via internet 330, which may be transmitted to and/or received by the mobile device via its internet connectivity, and/or via its network access via wireless AP 312, cellular BS 314, Bluetooth® emitter 316, and/or NFC terminal 318.

Internet 330 may include a system of interconnected networks and/or devices that enable exchange of information and/or data among a plurality of nodes, based on one or more networking standards, including, for example, Internet Protocol (IP). Internet 330 may enable, for example, connectivity among a plurality of private and public, academic, business, and/or government nodes and/or networks, wherein the physical connectivity may be provided via the Public Switched Telephone Network (PSTN), utilizing copper wires, fiber-optic cables, wireless interfaces, and/or other standards-based interfaces.

Various devices and/or user identification information may be utilized during network access and/or communications, which may be structured, allocated, and/or assigned based on the specific wired and/or wireless protocols that are used to facilitate any such network access and/or communication. For example, in GSM and/or WCDMA based networks, International Mobile Equipment Identity (IMEI) parameters may be utilized to uniquely identify mobiles devices, and these IMEI parameters may also be used and/or traced back to the mobile devices' users. Service providers may utilize the device and/or user identification information to track mobile devices and/or users. The service providers may track devices and/or users for various reasons, including, for example, billing or usage monitoring, and/or to help locate mobile devices, and/or their users, in cases of emergency and/or law enforcement purposes. Tracking of devices may also be used to provide authorized LBS and/or real-time device location information which can be utilized by eco-system enabled applications, such as exemplary embodiments of eco-system enabled applications according to the present disclosure, running on the mobile device or other devices and/or systems.

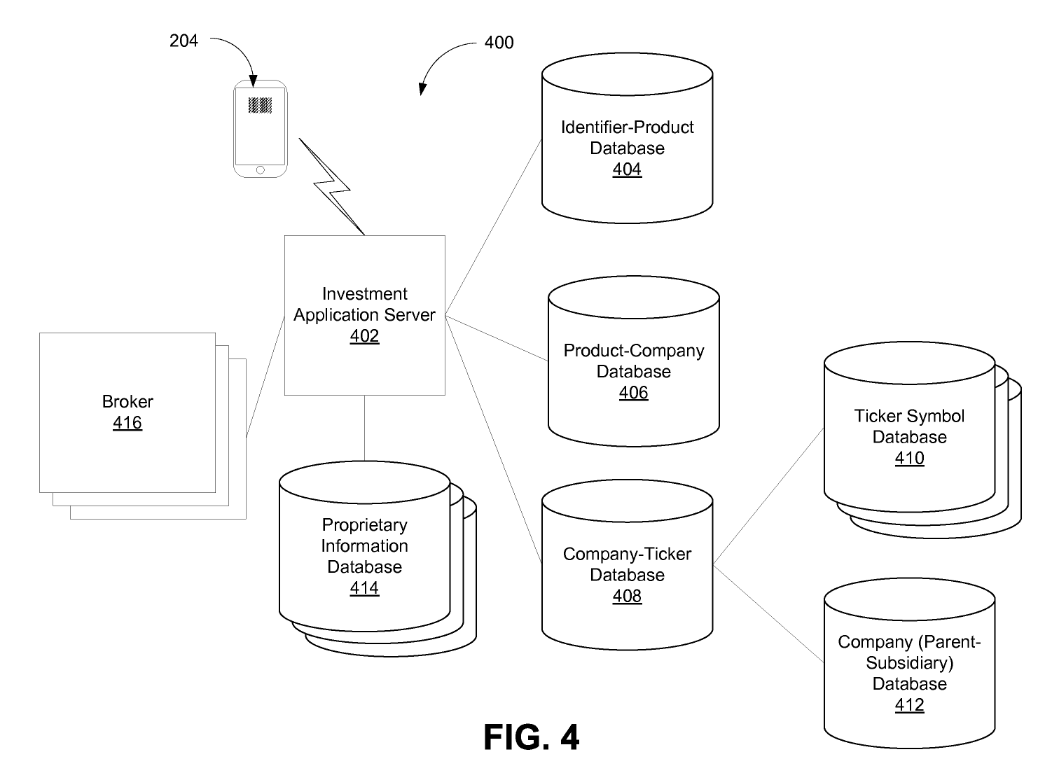

As mentioned previously, the investment application can be linked to informational resources or similar data repositories/databases, services, etc., in order to effectuate the correlation of, e.g., a UPC, to a ticker symbol, for the purposes of engaging in investment or investment-related activities. FIG. 4 illustrates an example system 400 in which various embodiments can be implemented to allow investment application 206 running on device 204 to provide investment or investment-related functionality as described in the present disclosure.

System 400 may include an investment application server 402 with which device 204 (on which investment application 206 can run) may operatively communicate. Upon scanning a UPC or other product or service identifier, investment application 206 may relay that UPC information to investment application server 402. Investment application server 402 may include one or more processors/controllers for performing various functions described herein. Investment application server 402 may query an identifier-product database 404 to obtain product information associated with the scanned UPC information. Moreover, investment application server 402 may include one or more communications devices for communicating with device 204/investment application 206 and various databases, services, etc. by way of communications system 300. Once the product information is obtained, investment application server 402 may further query a product-company database 406 to obtain information regarding a company associated with the product, e.g., the company that manufactures and/or distributes the product. It should be noted that in some instances, obtaining the product information is sufficient to obtain the associated company information. For example, investment application server 402 may scan a product UPC, such as a can of Diet Coca-Cola® and be able to directly ascertain that the associated company is the Coca-Cola Company.

Upon obtaining the company associated with the product, investment application server 402 may query yet another database, a company-ticker database 408 that may contain information mapping known companies to their known ticker symbols. It should be noted that the company-ticker database 408, via an integrated server(s) or under the control of one or more processors, may itself query a ticker symbol database 410 to obtain ticker symbol information and/or to update/alter company-ticker associations in company-ticker database 408. Company-ticker database 408 may also query a company database 412, in the event an associated company is determined not to have a ticker symbol, in which case, the associated company may be, e.g., a subsidiary of a parent company that may have a ticker symbol applicable to the scanned UPC. In accordance with one embodiment, determining whether a company is publicly traded can be ascertained by the existence of a ticker symbol associated with the company or lack thereof. For example, if a ticker symbol associated with a company of interest is found upon querying one or more of company-ticker database 408, ticker symbol database 410 and/or company database 412, it may be assumed that the company is publicly traded. If no associated ticker symbol is found, it may be assumed that the company is privately held.

Once the company is correlated with a ticker symbol, investment application server 402 may relay that information to application 206 running on device 204, thereby allowing application investment 206 to present that information to a consumer using device 204. It should be noted that a plurality of ticker symbol databases can be accessed/queried depending on the exchange in which a publicly owned company may be traded, nationally or internationally, e.g., the New York Stock Exchange (NYSE), NASDAQ, AMEX, Pink Sheets, Euronext, OMX, etc. Thus, investment application 206 may be utilized globally to identify ticker symbols, provide relevant investment-related information, etc. in accordance with various embodiments.

As also previously described, investment application 206 may provide investment-related information to the consumer, such as spark charts. Information used in generating such spark charts, or the spark charts themselves, may be stored and/or accessed from a proprietary information database 414, such as that which can be controlled and maintained by an entity having such information, e.g., an acquiring bank, or one more other entities having such information. Additionally, proprietary information database 414 may include a searchable data repository containing information, records, and/or listings of private and public companies, including those maintained by governmental agencies, such as the U.S. Securities and Exchange Commission (SEC), private entities, etc. Accordingly, determining whether a company is publicly traded can be determined by accessing proprietary information database 414 (as an alternative to the aforementioned reliance on ticker symbol existence or in addition thereto, e.g., as a method of verification). Further still, investment application server 402 may access one or more brokerage firms/services 416 in order to provide effectuate the aforementioned investment or investment-related activities, such as the purchase or sale of stock using the ticker symbol of a company identified by the scanning of a UPC as described in the present disclosure.

It should be noted that the aforementioned functionality may be incorporated into investment application 402 in accordance with other embodiments. Implementation of the aforementioned databases may include one or more databases or database partitions, and may be co-located or remotely located from each other and/or other system elements, such as investment application server 402. Such databases may be maintained and/or controlled by various entities, including third party entities, such as financial agency, a governmental agency, etc., depending on the nature of the information data being maintained. For example, company-ticker database 408 may be a Dunn & Bradstreet database that licenses information on corporations for use in credit decisions, marketing, etc. The aforementioned databases may be connected via one or more networks and/or communication links, whether wired or wireless. Any automated queries and/or searching for relevant information or data can involve one or more system elements, such as investment application server 402 accessing one or more data networks, such as internet 300 or other data network.

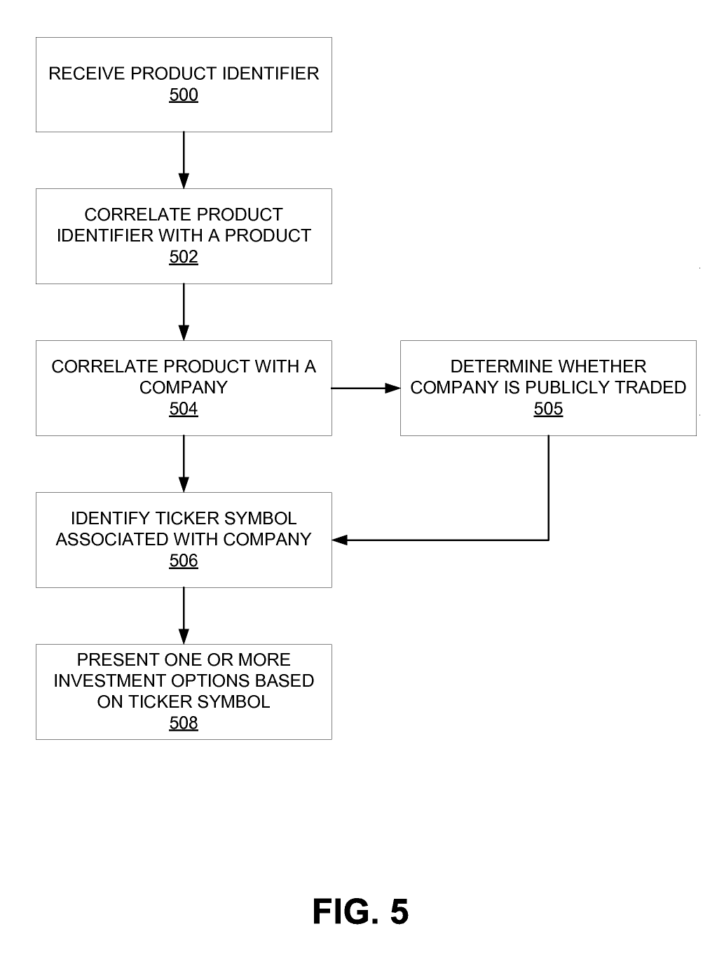

FIG. 5 is a flow chart illustrating various operations performed to correlate a product or service identifier with a ticker symbol, which may then be utilized to engage in one or more investment or investment-related activities. At operation 500, a product or service identifier may be received. As described above, an application, e.g., investment application 206, may receive a product or service identifier via scanning, augmented reality, receipt of broadcast information, or via some other method of input or entry. For example, a user of a mobile device, such as device 204, may scan the UPC of a product, take a picture or view the product through device 204, receive proximity marketing information with some form of product or merchant identifier embedded or included therein, or via user input on device 204. At operation 502, the product identifier is correlated with a product. That is, one or more databases may be queried in order to determine what product is identified by the scanned UPC. At operation 504, the identified product is correlated with a company. Again, one or more databases can be accessed, or one or more queries via a data network, such as the Internet, can be performed to determine what company is associated with the identified product. In some instances, determining the company can be performed upon identification of the product, if for example, the name of the company is part of the product name. At operation 506, a ticker symbol associated with the company is identified. One or more database may also be accessed or queried to determine what ticker symbol is associated with the company, if it is determined that the company is, e.g., a publicly owned/traded entity. It should be noted that prior to identifying a ticker symbol, it may be determined whether the company is publicly traded at operation 505. Alternatively, determining whether the company is publicly traded can be determined based upon the existence or absence of a ticker symbol during identification of a ticker symbol at operation 506. At operation 508, one or more investment options based on the ticker symbol are presented, e.g., to a consumer/user of investment application 206. For example, spark charts or other related/relevant information regarding, e.g., the financial standing, of the identified company can be presented, as well as one or more options for engaging in investment activities, such as a purchasing or selling stock in the identified company.

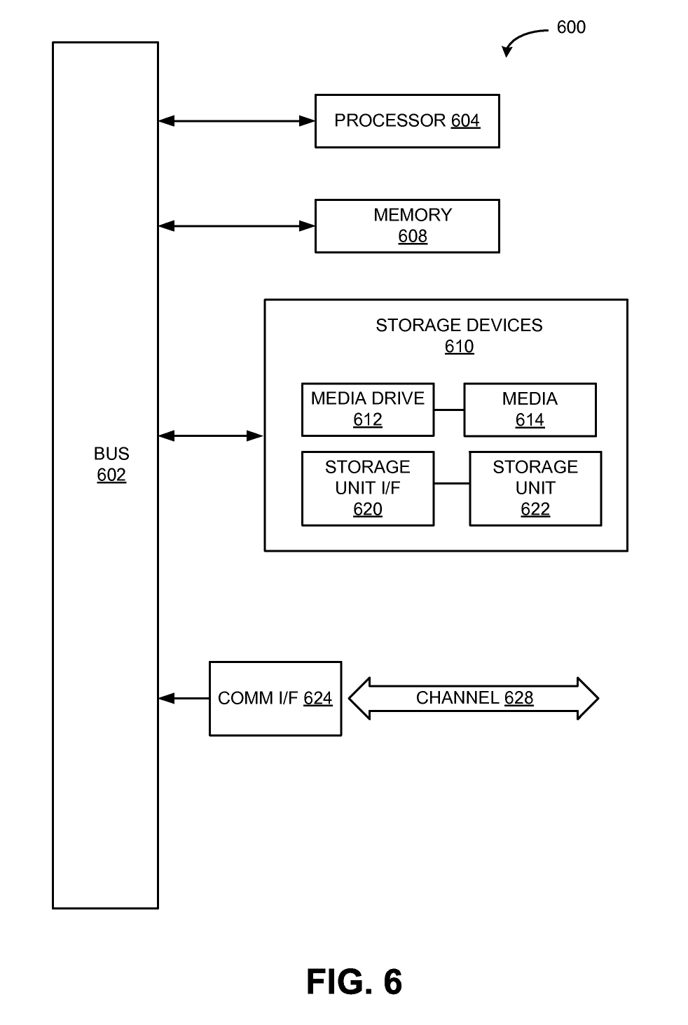

FIG. 6 illustrates an example computing module 600, an example of which may be a processor/controller resident on device 204 for executing investment application 206, or a processor/controller used to operate investment application server 402, that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 5. Various embodiments are described in terms of this example-computing module 500. After reading this description, it will become apparent to a person skilled in the relevant art how to implement the application using other computing modules or architectures.

Conventional methods of determining a ticker symbol would generally require the consumer to “manually” perform a variety of searches from oftentimes, disparate sources of information. Additionally, obtaining investment or financial information related to a company often may also involve engaging in investigative searching using multiple data repositories and/or accessing a plurality of services in order to determine whether or not investing in a particular company would be desirable to the consumer. In contrast, various embodiments allow, e.g., a consumer, to identify a product of interest, and automatically receive a ticker symbol for a company or corporate entity associated with the product of interest of the company or corporate entity is publicly traded on a stock exchange. Using the received ticker symbol, the consumer may quickly and efficiently engage in one or more investment or investment-related activities.

Referring now to FIG. 6, computing module 600 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 600 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 600 might include, for example, one or more processors, controllers, control modules, or other processing devices, such as a processor 604. Processor 604 might be implemented using a general-purpose or special-purpose processing engine such as, for example, a microprocessor, controller, or other control logic. In the illustrated example, processor 604 is connected to a bus 602, although any communication medium can be used to facilitate interaction with other components of computing module 600 or to communicate externally.

Computing module 600 might also include one or more memory modules, simply referred to herein as main memory 608. For example, preferably random access memory (RAM) or other dynamic memory might be used for storing information and instructions to be executed by processor 604. Main memory 608 might also be used for storing temporary variables or other intermediate information during execution of instructions to be executed by processor 604. Computing module 600 might likewise include a read only memory (“ROM”) or other static storage device coupled to bus 602 for storing static information and instructions for processor 604.

The computing module 600 might also include one or more various forms of information storage devices 610, which might include, for example, a media drive 612 and a storage unit interface 620. The media drive 612 might include a drive or other mechanism to support fixed or removable storage media 614. For example, a hard disk drive, a floppy disk drive, a magnetic tape drive, an optical disk drive, a CD or DVD drive (R or RW), or other removable or fixed media drive might be provided. Accordingly, storage media 614 might include, for example, a hard disk, a floppy disk, magnetic tape, cartridge, optical disk, a CD or DVD, or other fixed or removable medium that is read by, written to or accessed by media drive 612. As these examples illustrate, the storage media 614 can include a computer usable storage medium having stored therein computer software or data.

In alternative embodiments, information storage devices 610 might include other similar instrumentalities for allowing computer programs or other instructions or data to be loaded into computing module 600. Such instrumentalities might include, for example, a fixed or removable storage unit 622 and a storage unit interface 620. Examples of such storage units 622 and storage unit interfaces 620 can include a program cartridge and cartridge interface, a removable memory (for example, a flash memory or other removable memory module) and memory slot, a PCMCIA slot and card, and other fixed or removable storage units 622 and interfaces 620 that allow software and data to be transferred from the storage unit 622 to computing module 600.

Computing module 600 might also include a communications interface 624. Communications interface 624 might be used to allow software and data to be transferred between computing module 600 and external devices. Examples of communications interface 624 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 624 might typically be carried on signals, which can be electronic, electromagnetic (which includes optical) or other signals capable of being exchanged by a given communications interface 624. These signals might be provided to communications interface 624 via a channel 628. This channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 608, storage unit interface 620, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 600 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method, comprising:
receiving a product identifier;
correlating the product identifier with a product;
correlating the product with a company;
identifying a ticker symbol associated with the company; and
presenting at least one investment option based on the ticker symbol.

2. The method of claim 1, wherein the product identifier comprises one of a universal product code (UPC), a stock keeping unit (SKU), a serial number, a manufacturer part number (MPN), a European article number (EAN), or an international standard book number (ISBN).

3. The method of claim 1, wherein receiving the product identifier comprises one of scanning the product identifier or taking a picture of the product via an investment application implemented on a mobile device.

4. The method of claim 1, wherein correlating the product identifier with the product comprises accessing a first database relating the product identifier and the product.

5. The method of claim 1, wherein correlating the product with a company comprises accessing a second database relating the product and the company.

6. The method of claim 1, wherein the company comprises a parent of a subsidiary identified as being associated with the product, the association between the company and the subsidiary being determined by accessing a third database.

7. The method of claim 1, wherein identifying the ticker symbol comprises accessing a fourth database relating the company and the ticker symbol.

8. The method of claim 1, wherein the at least one investment option comprises one of purchasing stock in the company, selling stock in the company, and viewing investment-related information regarding the company.

9. The method of claim 8, further comprising redirecting to a brokerage service to perform the purchasing of the stock and the selling of the stock.

10. The method of claim 1, further comprising receiving a merchant identifier embedded in a proximity marketing broadcast message.

11. The method of claim 1, further comprising receiving an investment recommendation based upon an additional ticker symbol associated with an additional company, the additional ticker symbol being identified via at least one locations based services, near field communications transmissions, social media networking, analyzing prior purchasing or investment history.

12. A non-transitory computer-readable medium having computer executable program code embodied thereon, the computer executable program code configured to cause a computer system to:
correlate a product to a scanned identification code displayed on the product;
correlate the product with a company determined to be associated with the product;
determine whether the company is a publicly traded company;
if the company is determined to be publicly traded, identify a ticker symbol associated with the company; and
present a plurality of investment-related activity options using the ticker symbol on a graphical user interface menu.

13. The non-transitory computer-readable medium of claim 12, wherein the scanned identification code comprises one of a universal product code (UPC), a stock keeping unit (SKU), a serial number, a manufacturer part number (MPN), a European article number (EAN), or an international standard book number (ISBN).

14. The non-transitory computer-readable medium of claim 12, wherein the plurality of investment-related activity options comprises at least purchasing stock in the company, selling stock in the company, and viewing a spark chart regarding the company.

15. The non-transitory computer-readable medium of claim 14, wherein the computer executable program code is configured to further cause the computer system to access a one of an external brokerage service or an internal trading exchange platform to complete the purchasing and the selling of stock in the company.

16. The non-transitory computer-readable medium of claim 14, wherein the computer executable program code is configured to further cause the computer system to access an acquiring bank proprietary database maintaining payment card transaction data for use in generating the spark chart.

17. A server, comprising:
at least one processor; and
at least one memory module storing computer program code, wherein the at least one memory module and stored computer program code are configured to, with the at least one processor, cause the server to:
determine a product associated with a product code received from an investment application by accessing a first database mapping the product code to the product and retrieving first information identifying the product;
determine a company associated with the product by accessing a second database mapping the product to the company and retrieving second information naming the company;
determine a ticker symbol associated with the company by accessing a third database mapping the company to the ticker symbol and retrieving the ticker symbol;
visually present the ticker symbol; and
enable selection of at least one investment option regarding the company utilizing the ticker symbol.

18. The server of claim 17, wherein the product code comprises one of a universal product code (UPC), a stock keeping unit (SKU), a serial number, a manufacturer part number (MPN), a European article number (EAN), or an international standard book number (ISBN).

19. The server of 17, wherein the at least one memory module and stored computer program code are configured to, with the at least one processor, further cause the server to determine whether the company is a publicly traded company.

20. The server of 17, wherein the at least one investment option comprises one of purchasing stock in the company, selling stock in the company, and viewing a spark chart regarding the company.
